(19) United States
(12) Patent Application Publication
(10) Pub. No.: US 2024/0351945 A1
(43) Pub. Date: Oct. 24, 2024

(54) GLASS CERAMIC SUBSTRATE WITH THROUGH-GLASS VIA

(71) Applicant: CORNING INCORPORATED, CORNING, NY (US)

(72) Inventors: Daniel Wayne Levesque, JR., Bath, NY (US); Lina Ma, Corning, NY (US); Heather Nicole Vanselous, Corning, NY (US); Jingshi Wu, Painted Post, NY (US)

(21) Appl. No.: 18/687,920

(22) PCT Filed: Aug. 23, 2022
(86) PCT No.: PCT/US2022/041190

§ 371 Date: Feb. 29, 2024

Related U.S. Application Data
(60) Provisional application No. 63/240,148, filed on Sep. 2, 2021.

(51) Int. Cl. C03C 23/00; C03C 10/00; C03C 15/00

(52) U.S. Cl. CPC C03C 23/0025; C03C 10/0036; C03C 15/00; C03C 2204/00

(57) ABSTRACT

A method of forming a glass ceramic substrate having a through-glass via can include treating at least a portion of a first major surface of a precursor glass substrate along a laser scan path with a source of laser energy to form a treated precursor glass substrate. The through-glass via has a predetermined shape and extends through the first major surface of the glass ceramic substrate and a second major surface of the glass ceramic substrate. The first major surface defines a first opening and the second major surface defining a second opening and a ratio of a waist diameter of the through-glass via, measured at a location between the first opening and the second opening, to a surface diameter of the through-glass via, measured at either the first opening of the second opening of the through-glass via is in a range of from about 30% to about 100%.

### CROSS-REFERENCE TO RELATED APPLICATIONS

This application claims the benefit of priority under 35 U.S.C. § 119 of U.S. Provisional Application No. 63/240,148 filed Sep. 2, 2021, the content of which is incorporated herein by reference in its entirety.

### BACKGROUND

### Field

The present disclosure generally relates to articles having vias etched therein. In particular, the present disclosure is directed to articles having vias with a particular geometry, as well as to laser and etching processes for fabricating such articles.

### Technical Background

Substrates, such as silicon, have been used as an interposer disposed between electrical components (e.g., printed circuit boards, integrated circuits, and the like). Metalized through-substrate vias provide a path through the interposer for electrical signals to pass between opposite sides of the interposer. Glass is a substrate material that is highly advantageous for the application on interposer field, as it has dimensional stability, a tunable coefficient of thermal expansion (“CTE”), low electrical loss at high frequencies electrical performance, good thermal stability, and an ability to be formed at certain thickness and at large panel sizes. However, through-glass via (“TGV”) formation and metallization present challenges in development of the glass interposer markets.

Via geometry attributes play a role in the ability for vias within a glass-based substrate to be properly metalized. For example, during a sputter metallization process, the angle of the taper of a side wall of a via may increase the field of view of the via sidewall relative to the sputtered material, which, in turn, prevents the encapsulation of air bubbles against the glass surface and toward the centerline of the via. These air bubbles create processing issues during high temperature redistribution layer (“RDL”) operations and may decrease the reliability of the substrate.

Accordingly, a need exists for substrates having particular via geometries, as well as methods of forming the same.

### SUMMARY OF THE INVENTION

According to various aspects, a method of forming a glass ceramic substrate having a through-glass via can include treating at least a portion of a first major surface of a precursor glass substrate along a laser scan path with a source of laser energy to form a treated precursor glass substrate. This can be followed by treating the treated precursor glass substrate with an etchant to form an etched precursor glass substrate. This can be followed by ceraming the etched treated precursor glass to form substrate comprising the through-glass via. Alternatively, the method can include treating at least a portion of a first major surface of a precursor glass substrate along a laser scan path with a source of laser energy to form a treated precursor glass substrate. This can be followed by ceraming the treated precursor glass substrate to form a treated ceramed precursor glass substrate. This can be followed by treating the treated ceramed precursor glass substrate with an etchant to form a glass ceramic substrate comprising the through-glass via. Alternatively, the method can include ceraming a precursor glass substrate to form a ceramed precursor glass substrate. This is followed by treating at least a portion of a first major surface of the ceramed precursor glass substrate along a laser scan path with a source of laser energy to form a treated ceramed precursor glass substrate. This is followed by treating the treated ceramed precursor glass substrate with an etchant to form an etched ceramed precursor glass substrate to form a glass ceramic substrate comprising the through-glass via in the glass ceramic substrate. The through-glass via has a predetermined shape and extends through the first major surface of the glass ceramic substrate and a second major surface of the glass ceramic substrate. The first major surface defines a first opening and the second major surface defining a second opening and a ratio of a waist diameter of the through-glass via, measured at a location between the first opening and the second opening, to a surface diameter of the through-glass via, measured at either the first opening or the second opening of the through-glass via is in a range of from about 30% to about 100%.

According to various aspects of the present disclosure, a glass ceramic substrate can include a plurality of through-glass vias independently having a major diameter in a range of from about 10 μm to about 150 μm. The through-glass via extends through a first major surface of the glass ceramic substrate and a second major surface of the glass ceramic substrate. The first major surface defining a first opening and the second major surface defining a second opening and a ratio of a waist diameter of the through-glass via, measured at a location between the first opening and the second opening, to a surface diameter of the through-glass via, measured at either the first opening or the second opening of the through-glass via is in a range of from about 30% to about 100%. The glass ceramic substrate is substantially free of an alkali ion.

### BRIEF DESCRIPTION OF THE FIGURES

The drawings illustrate generally, by way of example, but not by way of limitation, various embodiments of the present invention.

FIG. 1 schematically depicts an illustrative semiconductor assembly including a glass interposer according to one or more embodiments shown and described herein.

FIG. 2A schematically depicts an illustrative article configured as a wafer having vias therein according to one or more embodiments shown and described herein.

FIG. 2B schematically depicts a top view of a portion of an illustrative wafer having vias therein according to one or more embodiments shown and described herein.

FIG. 3A schematically depicts a cross-sectional side view of an illustrative via geometry according to one or more embodiments shown and described herein.

FIG. 3B schematically depicts a detailed view of a change in slope between two tapered regions of an interior wall of the via of FIG. 3A according to one or more embodiments shown and described herein.

FIG. 3C schematically depicts a cross-sectional side view of another illustrative via geometry according to one or more embodiments shown and described herein.

FIG. 3D schematically depicts a cross-sectional side view of yet another via geometry according to one or more embodiments shown and described herein.

FIG. 3E schematically depicts a cross-sectional side view of yet another via geometry according to one or more embodiments shown and described herein.

FIG. 3F schematically depicts a cross-sectional side view of yet another via geometry according to one or more embodiments shown and described herein.

FIG. 3G schematically depicts a cross-sectional side view of an illustrative cylindrical via having a particular via geometry according to one or more embodiments shown and described herein.

FIG. 4 schematically depicts a cross-sectional side view of a portion of an illustrative taper, indicating lengths of various tapered regions of an interior wall thereof according to one or more embodiments shown and described herein.

FIG. 5 schematically shows three possible processes for forming glass ceramic substrates.

FIG. 6A schematically shows the profile of different vias formed using lasers of different powers.

FIG. 6B shows a graph of the different Dw/D1 ratios of vias formed at different laser powers.

FIG. 7 schematically shows that existing bias shrink during processing but that no structural defects are observed.

FIG. 8 shows a series of histograms displaying the geometries of various vias before and after ceraming.

FIG. 9 schematically shows the change of via diameters in a substrate before and after heat treatment.

FIG. 10A schematically shows the change in dielectric constant between a precursor substrate and a creamed substrate.

FIG. 10B schematically shows the change in loss tangent between a precursor substrate and a creamed substrate.

FIG. 11 shows pictures and data comparing the resulting shapes of vias formed by different processes.

FIG. 12 shows a rating scale for evaluating the surface roughness of vias.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The methods and techniques described herein allow for the rapid ability to form through-glass vias in glass substrates. The methods importantly allow for the control of the shape of the through-glass vias. This gives a user a great degree of control in the shape of the through-glass via that could not otherwise be achieved.

Referring generally to the figures, embodiments of the present disclosure are generally related to articles having vias (e.g., holes) and surface attributes which allow for successful downstream processing including, but not limited to, via metallization and application of redistribution layers (RDL). The article may be for use in semiconductor devices, radio-frequency (RF) devices (e.g., antennae, switches, and the like), interposer devices, microelectronic devices, optoelectronic devices, microelectronic mechanical system (MEMS) devices and other applications where vias may be leveraged.

More particularly, embodiments described herein are directed to glass-based articles having vias formed by a laser damage and etch process that include a particular interior wall geometry, such as an interior wall having a plurality of regions that each have a distinctive slope. Ultimately, the vias may be coated or filled with an electrically conductive material. Vias having particular interior wall geometries may increase the reliability of downstream processes, such as metallization processes. For example, the particular geometries of the interior walls may prevent the encapsulation of air bubbles against the surface of the side wall during the metallization process.

Embodiments of the present disclosure are further directed to laser forming and etching processes that result in glass-based articles having vias with the desired geometry. Articles, such as glass articles, having the desired via geometry described herein may be implemented as an interposer in a semiconductor device, such as an RF antenna, for example.

Various embodiments of articles, semiconductor packages, and methods of forming a via in a substrate are described in detail below.

The term “interposer” generally refers to any structure that extends or completes an electrical connection through the structure, for example but not limited to, between two or more electronic devices disposed on opposite surfaces of the interposer. The two or more electronic devices may be co-located in a single structure or may be located adjacent to one another in different structures such that the interposer functions as a portion of an interconnect nodule or the like. As such, the interposer may contain one or more active areas in which through-glass vias and other interconnect conductors(such as, for example, power, ground, and signal conductors) are present and formed. The interposer may also include one or more active areas in which blind vias are present and formed. When the interposer is formed with other components, such as dies, underfill materials, encapsulants, and/or the like, the interposer may be referred to as an interposer assembly. Also, the term “interposer” may further include a plurality of interposers, such as an array of interposers or the like.

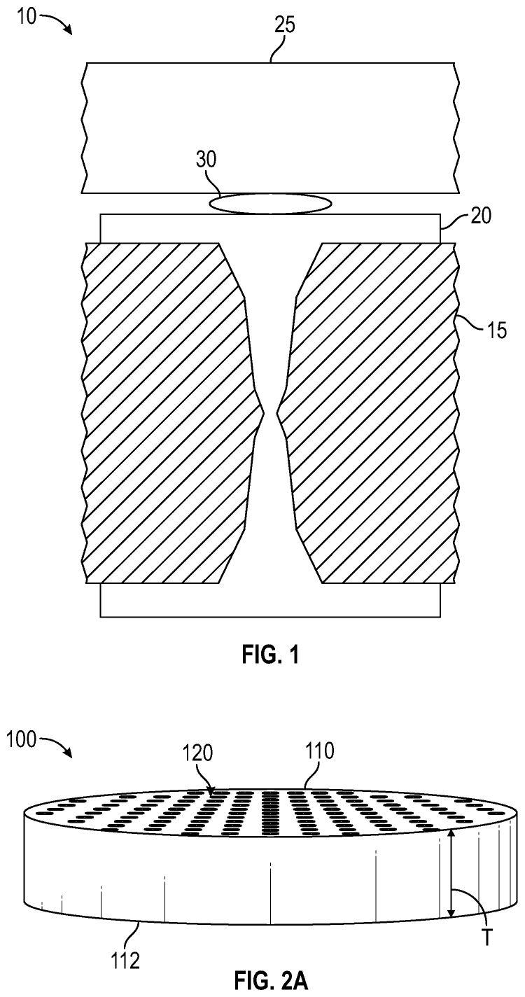

FIG. 1 depicts an illustrative example of a semiconductor package, generally designated 10, that includes an article 15, a conductive material 20, and a semiconductor device 25. The various components of the semiconductor package 10 may be arranged such that the conductive material 20 is disposed on at least a portion of the article 15, such as, for example, disposed within the via of the substrate of the article 15, as described in greater detail herein. The semiconductor device 25 may be coupled such that the semiconductor device 25 is in electrical contact with the conductive material 20. In some embodiments, the semiconductor device 25 may directly contact the conductive material 20. In other embodiments, the semiconductor device 25 may indirectly contact the conductive material 20, such as via bumps 30 and/or the like.

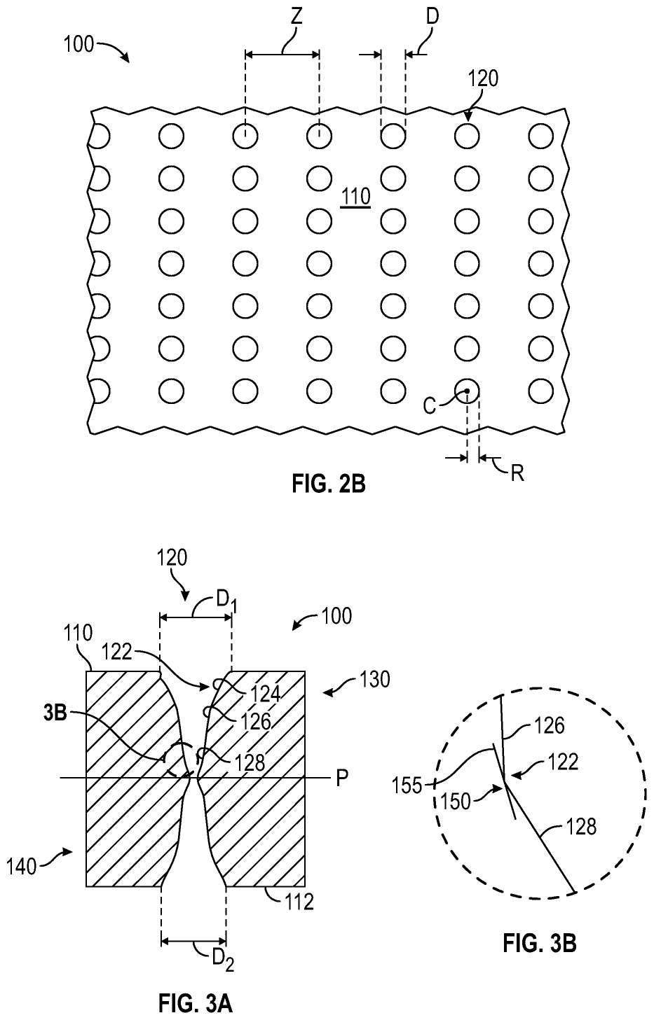

FIG. 2A schematically illustrates a perspective view of an exemplary substrate 100 having a plurality of vias 120 disposed therein. FIG. 2B schematically depicts a top-down view of the example article depicted in FIG. 2A. Although FIGS. 2A and 2B depict the substrate 100 configured as a wafer, it should be understood that the article may take on any shape, such as, without limitation, a panel. The substrate 100 may be generally planar and may have a first major surface 110 and a second major surface 112 positioned opposite to and planar with the first major surface 110.

The articles described herein can be fabricated from a light-transmissive material capable of allowing radiation having a wavelength within the visible spectrum to pass therethrough. For example, the substrate 100 may transmit at least about 70%, at least about 75%, at least about 80%, at least about 85%, or at least about 90% of at least one wavelength in a range from about 390 nm to about 700 nm over a thickness in a range of from about 0.5 mm to about 1.5 mm or about 0.7 mm to about 1 mm. Alternatively, some articles can be fabricated from an opaque material that does not allow light to transmit therethrough.

The substrate 100 may be a glass-based substrate. Glass-based substrate materials are materials partly or wholly made of glass. As described herein, the glass of the substrate is an alkali-free glass (for example an alkali-free alkaline aluminoborosilicate glass). Examples of such glasses can include a mixture of: SiO₂(50 to 70 mol %), Al₂O₃(12 to 22 mol %), B₂O₃(0 mol %), a mixture of: MgO, CaO, SrO, and BaO (0 to 15 mol %), MgO (0 to 15 mol %), BaO (0 to 2 mol %), ZnO (0 to 22 mol %), ZrO₂(0 to 6 mol %), TiO₂(0-8 mol %), SnO₂ (0.01-0.1 mol %), or a mixture thereof. In some embodiments, the substrate 100 may be a laminate of glass layers, glass ceramic layers, or a combination of glass and glass ceramic layers. For example, the substrate 100 may be formed from soda-lime glass batch compositions or other glass batch compositions which may be strengthened by ion exchange after formation.

A glass ceramic material is understood to relate to polycrystalline or nanocrystalline materials produced through controlled crystallization process of base or precursor glass. Glass ceramic materials share many properties with both glasses and ceramics. Glass ceramics have an amorphous phase and one or more crystalline phases and are produced by a so-called “controlled crystallization” or “ceraming” in contrast to a spontaneous crystallization, which is usually not wanted in glass manufacturing.

In some embodiments, the substrate 100 may have a low coefficient of thermal expansion (e.g., less than or equal to about 4 ppm/° C.) and in other embodiments, the substrate 100 may have a high coefficient of thermal expansion (e.g., greater than about 4 ppm/° C.). In the methods described herein, the coefficient of thermal expansion of the ceramed substrate 100 can be increased by about 15% to about 40% relative to a glass precursor of the substrate 100 or by about 20% to about 35%.

In some embodiments, the substrate 100 may have a density in a range of about 2 g/cm³ to about 4 g/cm³ or from 2.5 g/cm³ to about 3.5 g/cm³. In the methods described herein, the density of the ceramed substrate 100 can be increased by about 1% to about 4% relative to a glass precursor of the substrate 100 or by about 2% to about 3%. Additionally, in some embodiments, the precursor or ceramed substrate 100 may have a dielectric constant in a range of about 4 to about 8 or from about 5 to about 7. In the methods described herein, the dielectric constant of the ceramed substrate 100 can be decreased relative to a glass precursor of the substrate 100 by about 5% to about 15%.

As noted hereinabove, the substrate 100 may be implemented as an interposer in an electronic device to pass electrical signals through substrate 100, for example, but not limited to, between one or more electronic components coupled to a first major surface 110 and one or more electronic components coupled to a second major surface 112 of the substrate 100. The vias 120 of the substrate 100 are filled with an electrically conductive material to provide electrically conductive vias through which electrical signals may pass. The vias 120 formed according to the instant disclosure are controlled to be through-glass vias as opposed to blind vias. As used herein, a through-glass via extends through a thickness T of the substrate 100 from the first major surface 110 to the second major surface 112. As used herein, a blind via extends only partially through the thickness T of the substrate 100 from one of the first major surface 110 or the second major surface 112 but not all the way to the other of the first major surface 110 or the second major surface 112. Other features may be formed within the first major surface 110 or the second major surface 112 of the substrate 100, such as, without limitation, channels that may be metalized to provide one or more patterns of electrical traces. Other features may also be provided.

The substrate 100 has any size and/or shape, which may, for example, depend on the end application. As an example and not a limitation, the thickness T of the substrate 100 may be within a range of about 25 μm to about 3,000 μm, including about 25 μm, about 50 μm, about 75 μm, about 100 μm, about 200 μm, about 300 μm, about 400 μm, about 500 μm, about 600 μm, about 700 μm, about 800 μm, about 900 μm, about 1,000 μm, about 2,000 μm, about 3,000 μm, or any value or range between any two of these values (including endpoints).

The vias 120 of the substrate 100 may have an opening diameter D, for example, of about 10 μm to about 150 μm, including about 15 μm or less, about 20 μm or less, about 25 μm or less, about 30 μm or less, 35 μm or less, about 40 μm or less, about 50 μm or less, about 60 μm or less, about 70 μm or less, about 80 μm or less, about 90 μm or less, about 100 μm or less, about 110 μm or less, about 120 μm or less, about 130 μm or less, about 140 μm or less, about 150 μm or less, or any value or range between any two of these values (including endpoints). As used herein, the opening diameter D (e.g., D₁ or D₂) refers to a diameter of the opening of the via 120 at the first major surface 110 or at the second major surface 112 of the substrate 100. The diameter of the opening of the via 120 at the first major surface 110 or of the opening at the second major surface 112 can be the same value or a different value. Typically, at least one of the opening at the first major surface 110 or the second surface 112 define the major dimension (e.g., largest diameter) of the via 120. The opening of the via 120 is generally at a location that marks a transition between the substantially horizontal major surface 110, 112 and a sloped surface of a wall of the via 120. The opening diameter D of the vias 120 may be determined by finding a diameter of a least-squares best fit circle to the edges of the entrance to the vias 120 as imaged by an optical microscope.

Similarly, the vias 120 of the substrate 100 may have an opening radius R of about 5 μm to about 150 μm. As used herein, the opening radius R refers to the radius from a center point C of the opening of the via 120 at the first major surface 110 or at the second major surface 112 of the substrate 100.

A pitch Z of the vias 120, which is the center-to-center spacing between adjacent vias 120, may be any dimension according to the desired application, such as, without limitation, about 10 μm to about 2,000 μm, including about 10 μm, about 50 μm, about 100 μm, about 250 μm, about 1,000 μm, about 2,000 μm, or any value or range between any two of these values (including endpoints). In some embodiments, the pitch Z may vary between vias 120 on the same substrate 100 (e.g., the pitch Z between a first via and a second via may be different from a pitch Z between the first via and a third via). In some embodiments, the pitch Z may be a range, such as about 10 μm to about 100 μm, about 25 μm to about 500 μm, about 10 μm to about 1,000 μm, or about 250 μm to about 2,000 μm.

As defined herein, the average thickness T of the substrate 100 is determined by calculating the average of three thickness measurements taken outside of any depressed region on the first major surface 110 or the second major surface 112 due to the formation of the vias 120. As defined herein, the thickness measurements are taken by an interferometer. As described in more detail below, the laser damage and etch process may create depressed regions surrounding the holes formed within the substrate 100. Thus, the average thickness T is determined by measuring the thickness of the substrate 100 at three locations outside of the depressed region. As used herein, the phrase “outside of the depressed region” means that the measurement is taken at a distance in a range from about 500 μm and about 2,000 μm from the nearest via 120. Further, to obtain an accurate representation of the average thickness of the article, the measurement points should be at least about 100 μm away from one another. In other words, no measurement point should be within 100 μm of another measurement point.

As noted hereinabove, the vias 120 (and other features in some embodiments) may be filled with an electrically conductive material using any known technique including, but not limited to, sputtering, electroless and/or electrolytic plating, chemical vapor deposition, and/or the like. The electrically conductive material may be, for example, copper, silver, aluminum, titanium, gold, platinum, nickel, tungsten, magnesium, or any other suitable material. When the vias 120 are filled, they may electrically couple electrical traces of electrical components disposed on the first major surface 110 and the second major surface 112 of the substrate 100.

Controlling the geometry of the vias 120 may be important because the geometry may play a role in the quality of the resulting filling of the vias 120. The interior shape (e.g., profile) of the vias 120 may play significant roles in the success of the metallization process. For example, vias that are too “hourglass” in shape can lead to poor metallization and inadequate electrical performance after metallization. Metallization processes, such as vacuum deposited coatings, often have line-of-sight issues, meaning that applied coatings cannot reach the innermost areas of rough texture, or the lower region of an hourglass shaped via, because some points in the surface “shadow” others from the coating process. The same hourglass shapes can also lead to reliability issues post metallization, such as where cracking and other failures can occur when the part is subjected to environmental stress such as thermal cycling. Additionally, along the top and bottom surface of the article, depressions or mounds near the entrance and/or exit of the vias 120 can also lead to plating, coating, and bonding issues when redistribution layer processes are applied. Accordingly, tight control of the morphology of the holes should be present to fabricate a technically viable product. Embodiments of the present disclosure provide for articles having desired and predetermined geometric attributes, tolerances, and example fabrication processes for achieving articles having such geometric attributes and tolerances.

While specific reference has been made herein to vias 120 with different cross-sectional geometries through the thickness of the substrate 100, it should be understood that the vias 120 may include a variety of other cross-sectional geometries and, as such, the embodiments described herein are not limited to any particular cross-sectional geometry of the vias 120. Moreover, while the vias 120 are depicted as having a circular cross section in the plane of the substrate 100, it should be understood that the vias 120 may have other planar cross-sectional geometries. For example, the vias 120 may have various other cross sectional geometries in the plane of the substrate 100, including, without limitation, elliptical cross sections, square cross sections, rectangular cross sections, triangular cross sections, and the like. Further, it should be understood that vias 120 with different cross sectional geometries may be formed in a single interposer panel.

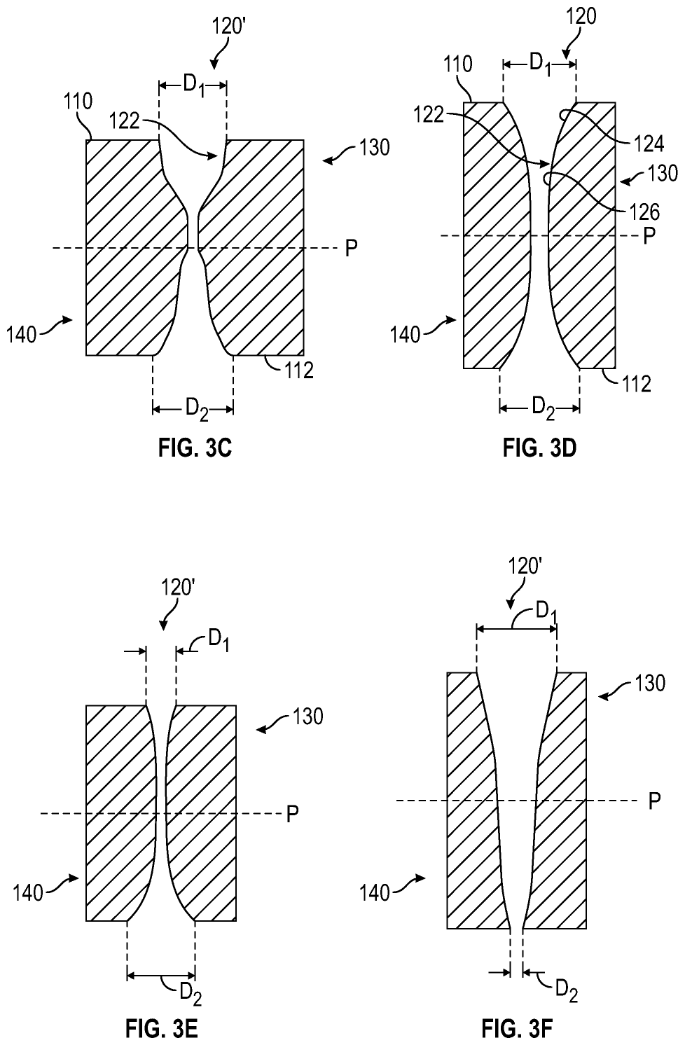

FIGS. 3A-3G schematically depict various illustrative vias within a substrate 100 in isolation. FIGS. 3A, 3C, 3D, 3E, and 3F each depict through-glass vias and FIG. 3G depicts a cylindrical through via. It should be understood that the portions of the description provided herein may be particularly directed to a specific one of FIGS. 3A-3G, but are generally applicable to any of the various embodiments depicted with respect to FIGS. 3A-3G, unless specifically stated otherwise.

FIG. 3A depicts a cross-sectional side view of an illustrative via 120 according to an embodiment. The via 120 may generally be a through-glass via because it extends an entire distance through the substrate 100 between the first major surface 110 and the second major surface 112 of the substrate 100. The first major surface 110 and the second major surface 112 may generally be parallel to one another and/or spaced a distance apart from each other. In some embodiments, the distance between the first major surface 110 and the second major surface 112 may correspond to the average thickness T (FIG. 2A). The tapered via 120 may generally include an interior wall 122 that extends the entire length of the tapered via 120. That is, the interior wall 122 extends from the first major surface 110 to the second major surface 112 of the substrate 100. The interior wall 122 includes a plurality of tapered regions, where each tapered region is distinguished from the other tapered regions by its relative slope, as described in greater detail herein. In a nonlimiting example, FIG. 3A depicts the interior wall 122 as having a first tapered region 124, a second tapered region 126, and a third tapered region 128, where each of the first tapered region 124, the second tapered region 126, and the third tapered region 128 have a different slope. It should be understood that the interior wall 122 may have greater or fewer tapered regions without departing from the scope of the present disclosure.

Each of the first tapered region 124, the second tapered region 126, and the third tapered region 128 may generally extend in a direction from the first major surface 110 towards the second major surface 112. While in some embodiments, a tapered region may extend in a direct line that is perpendicular to the first major surface 110 and the second major surface 112, this is not always the case. That is, in some embodiments, a tapered region may extend at an angle from the first major surface 110, but generally towards the second major surface 112. Such an angle may be referred to as a slope of a particular tapered region.

The slope of each of the various tapered regions (including the first tapered region 124, the second tapered region 126, and the third tapered region 128) of the interior wall 122 is not limited by this disclosure. That is, each of the tapered regions 124, 126, 128 may have any slope as calculated by any image processing software that is particularly configured to obtain an image of the tapered regions 124, 126, 128, extract a profile of the tapered regions 124, 126, 128 from the obtained image, and determine the slope from the profile at a particular point, at a plurality of points, and/or at a particular region. One such illustrative example of image processing software may include, but is not limited to, Igor Pro (WaveMetrics, Inc., Portland Oreg.).

Referring again to FIG. 3A, in some embodiments, the slope of each tapered region may be an angle relative to a particular axis at a particular point. For example, in some embodiments, the slope may be an angle relative to an axis that is substantially parallel to the first major surface 110 and/or the second major surface 112. In other embodiments, the slope of each tapered region may be an angle relative to an axis that is substantially perpendicular to the first major surface 110 and/or the second major surface 112. In some embodiments, the slope of each tapered region may be expressed as a ratio relative to axes that are perpendicular and parallel to the first major surface 110 and/or the second major surface 112. For example, the slope of a particular tapered region may be expressed as a ratio of 3:1, which generally means the slope is a hypotenuse of a right triangle that has a first leg extending 3 units in a first direction that is perpendicular to the first major surface 110 and/or the second major surface 112 and a second leg extending 1 unit in a second direction that is parallel to the first major surface 110 and/or the second major surface 112. Illustrative slopes of tapered regions (including the first tapered region 124, the second tapered region 126, and the third tapered region 128) may be from about 3:1 to about 100:1, including about 3:1, about 4:1, about 5:1, about 6:1, about 7:1, about 8:1, about 9:1, about 10:1, about 20:1, about 30:1, about 40:1, about 50:1, about 60:1, about 70:1, about 80:1, about 90:1, about 100:1, or any value or range between any two of these values(including endpoints).

In some embodiments, the transition area between the tapered regions may be pronounced, as shown in FIGS. 3A, 3C, and 3F. That is, the transition region may be a particular point 150 (FIG. 3B) or a region that is relatively short in length such that it may be easier to discern where each tapered region begins and ends relative to the other tapered regions. In other embodiments, the transition area between the tapered regions may be larger, as shown in FIGS. 3D and 3E such that the slope of the interior wall 122 appears to be continuously changing and it may be more difficult to discern where each tapered region begins and ends relative to the other tapered regions. For example, as shown in FIG. 3D, the transition area between the slope of the first tapered region 124 and the second tapered region 126 may be longer relative to the transition area between the slope of the first tapered region 124 and the second tapered region 126 as shown in FIG. 3A.

The length of each of the various tapered regions may vary, and are generally not limited by this disclosure. The length of each of the various tapered regions may be based on the number of tapered regions, the distance between the first major surface 110 and the second major surface 112, the slope of each tapered region, the size of the transition between tapered regions, and/or the like. A length of each particular region may be based on the endpoints for each particular region, as described in greater detail herein. For example, the first tapered region 124 may have a first endpoint that is located at the intersection of the interior wall 122 with the first major surface 110 and a second endpoint that is a point on the interior wall 122 where a constant slope of the interior wall 122 ends, for example the slope varies by at least 0.57 degrees from the slope of the first tapered region 124. Similarly, the second tapered region 126 may extend from an intersection with the first tapered region 124 towards the second major surface 112. It should be understood that the length, as used herein with respect to the various tapered regions (including a total length that includes all tapered regions combined), refers to a length of the interior wall 122 as it is traversed when following the contour/profile of the interior wall 122 from a start point to an end point.

In some embodiments, a length of a particular tapered region (including the first tapered region 124, the second tapered region 126, and/or the third tapered region 128) may be from about 15 μm to about 360 μm, including about 15 μm, about 25 μm, about 50 μm, about 75 μm, about 100 μm, about 150 μm, about 200 μm, about 250 μm, about 300 μm, about 350 μm, about 360 μm, or any value or range between any two of these values (including endpoints).

The via 120 may be symmetrical or asymmetrical about a plane P that is located between the first major surface 110 and the second major surface 112 and is equidistant between the first major surface 110 and the second major surface 112(e.g., midheight between the first major surface 110 and the second major surface). In addition, the plane P may further be substantially parallel to the first major surface 110 and the second major surface 112.

When the via 120 is symmetrical about the plane P, the various tapered regions of the interior wall 122 in a first portion 130 between the plane P and the first major surface 110 may be a mirror image of the various tapered regions of the interior wall 122 in a second portion 140 between the plane P and the second major surface 112. That is, at any given distance from the plane P in the first portion 130, a diameter of the via 120 will be substantially equal to a diameter of the via 120 at a corresponding distance from the plane P in the second portion 140. For example, as shown in FIGS. 3A and 3D, a first diameter D1 of the via 120 at an opening of the via 120 at the first major surface 110 in the first portion 130 is substantially equal to a second diameter D2 of the via 120 at the opening of the via 120 at the second major surface 112. As used herein with respect to the symmetrical shape, the term “substantially equal” refers to diameters that are equal within a tolerance limit. The tolerance limit may be less than or equal to 3 μm, less than or equal to about 2 μm, less than or equal to 1 μm, less than or equal to about 0.5 μm, less than or equal to about 0.25 μm, less than or equal to about 0.1 μm, or equal to about 0 μm.

In contrast, as shown in FIGS. 3C, 3E, and 3F, when another via 120′ is asymmetrical about the plane P, the various tapered regions of the interior wall 122 in the first portion 130 are not a mirror image of the various tapered regions of the interior wall 122 in the second portion 140. That is, as shown in FIGS. 3C, 3E, and 3F, the first diameter D1 of the via 120′ at any given location on the first portion 130 is not equal to a second diameter D2 of the via 120′ at the corresponding location in the second portion 140. In contrast to the tapered shapes of 3A-3F, another via 120 is shown in FIG. 3G where a cross-sectional profile of the via 120 is substantially cylindrical.

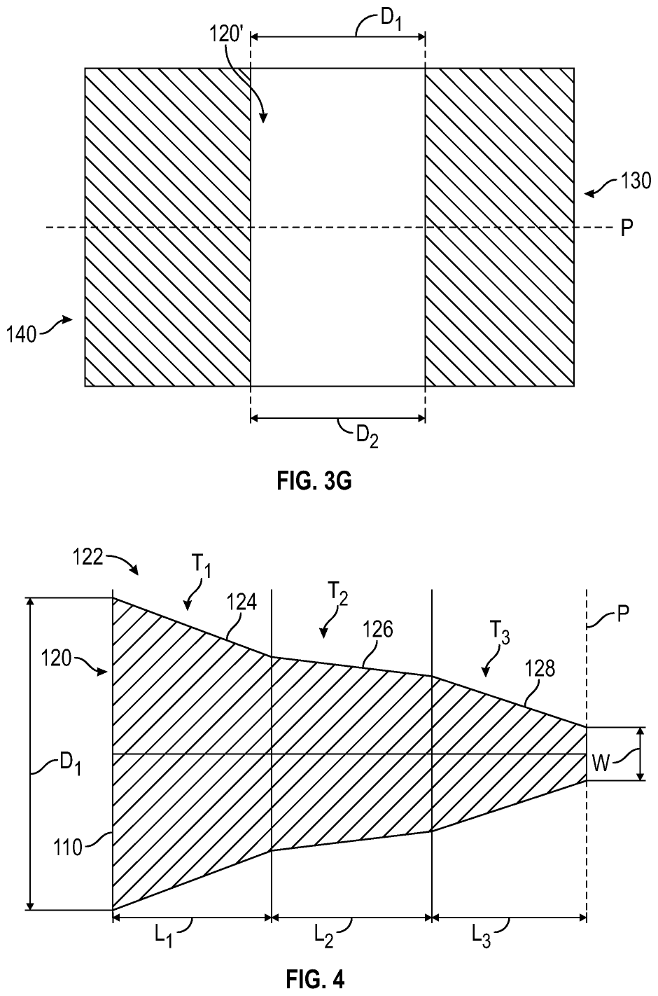

As shown in FIG. 4, the via 120 may have a particular waist diameter W at the plane P. In some embodiments, the waist diameter W may be within a range of about 30% to about 100% of a largest of the first diameter D1 and the second diameter (e.g., a ratio between the waist diameter relative to the largest of the first or the second diameter can be in a range of 30% to 100% (W/D1 or D2)*100)). In other embodiments, the waist diameter W may be about 85% of a largest of the first diameter D1 and the second diameter, about 90% of a largest of the first diameter D1 and the second diameter, about 30% to about 100% of a largest of the first diameter D1 and the second diameter, about 40% to about 100% of a largest of the first diameter D1 and the second diameter, about 50% to about 100% of a largest of the first diameter D1 and the second diameter, about 60% to about 100% of a largest of the first diameter D1 and the second diameter, about 70% to about 100% of a largest of the first diameter D1 and the second diameter, about 80% to about 100% of a largest of the first diameter D1 and the second diameter, or about 90% to about 100% of a largest of the first diameter D1 and the second diameter. In some embodiments, the waist diameter may be from about 5 μm to about 200 μm, including about 5 μm, about 10 μm, about 25 μm, about 50 μm, about 100 μm, about 200 μm, or any value or range between any two of these values (including endpoints).

As generally understood, the via 120 may be classified as having an hourglass cross-sectional profile if the waist diameter W is in a range of from about 10% to about 75% of the largest of the first diameter D1 or the second diameter or about 10% to about 50%. Furthermore, as generally understood, the via 120 may be classified as having cylindrical cross-sectional profile if the waist diameter W is in a range of from about 76% to about 100% of the largest of the first diameter D1 or the second diameter, or about 90% to about 100%.

The vias described herein can be formed by any one of three primary operations. For example, one method of forming the vias can include treating at least a portion of the first major surface of a precursor glass substrate along a laser scan path with a source of laser energy to form a treated precursor glass substrate. As used herein, a precursor glass is understood to refer to a glass substrate that does not include any of vias 120 or 120′ and is not yet a glass ceramic material. The method further includes, treating the treated precursor glass substrate with an etchant to form an etched treated precursor glass substrate. Finally, the method includes ceraming the etched precursor glass to form the substrate comprising the through-glass via.

Another example of forming the vias can include treating at least a portion of a first major surface of a precursor glass substrate along a laser scan path with a source of laser energy to form a treated precursor glass substrate. The method can further include ceraming the treated precursor glass substrate to form a treated ceramed precursor glass substrate. The method can further include treating the treated ceramed precursor glass substrate with an etchant to form a glass ceramic substrate comprising the through-glass via.

Another example of forming the vias can include ceraming a precursor glass substrate to form a ceramed precursor glass substrate. The method can further include treating at least a portion of a first major surface of the ceramed precursor glass substrate along a laser scan path with a source of laser energy to form a treated ceramed precursor glass substrate. The method can further include treating the ceramed treated precursor glass substrate with an etchant to form an etched ceramed precursor glass substrate to form a glass ceramic substrate comprising the through-glass via in the glass ceramic substrate.

Treating the precursor glass substrate along a laser scan path can include forming one or more laser damage regions in the precursor glass substrate. The laser damage region creates a damage area within the precursor glass substrate that etches at a faster etch rate than non-damaged regions upon application of an etching solution. The one or more damage tracks may be formed via a line-focused laser. However, the present disclosure is not limited to such a laser, and the one or more damage tracks may be formed with other lasers without departing from the scope of the present disclosure. The energy density of the laser (e.g., the energy delivered to the glass-based substrate) may be chosen such that it is above a damage threshold along at least a portion of the glass-based substrate (e.g., along an entire width of the glass-based substrate if a through-glass via is desired) and along an entire axis of the laser. Examples of the strength of the lase used can range from about 50 μJ to about 170 μJ or from about 70 μJ to about 140 μJ.

Etching can include treating the precursor glass with an etchant. Treating, for example, can include placing the precursor glass substrate in an etchant bath (e.g., a first etchant bath), which can cause the precursor glass substrate to be etched at a particular etch rate (e.g., a first etch rate) to remove the laser damaged region a portion of a via. In other embodiments, exposure to an etchant may be achieved through any conventional means including, but not limited to, spraying with etchant, or applying an etchant cream. The first etchant may be, for example, an acid etchant or a base etchant. Illustrative examples of acid etchants include, but are not limited to, etchants that contain an amount of nitric acid (HNO₃), etchants that contain hydrofluoric acid (HF), and/or the like. In one example, the etchant may include hydrofluoric acid that is present in a concentration of about 2 vol % to about 15 vol %. Illustrative examples of base etchants include, but are not limited to, etchants that are alkaline, such as sodium hydroxide (NaOH), potassium hydroxide (KOH), ammonium hydroxide (NH₄OH), and/or the like. However, other etchant baths now known or later developed may also be used without departing from the scope of the present disclosure. The etch rate is not limited by this disclosure, and may be any etch rate. In some embodiments, the etch rate may be about 0.002 μm/min to about 0.640 μm/min or about 10 μm to about 150 μm. A masking agent can be deployed over at least a portion of the precursor glass to prevent etching at certain locations. Moreover, strategic placement of the masking agent can influence the shape of the via. An example of a suitable masking agent can include poly(diallyldimethyl) ammonium chloride.

After a period time has elapsed and/or after a particular amount of the precursor glass substrate has been removed, the precursor glass substrate may be removed from the etchant (for example, an etchant bath). In some embodiments, the particular amount of time may be, for example, about 5 minutes to about 120 minutes, including about 5 minutes, about 15 minutes, about 30 minutes, about 60 minutes, about 120 minutes, or any value or range between any two of these values (including endpoints). In a particular embodiment, the particular amount of time may be about 75 minutes. In another particular embodiment, the particular amount of time may be about 14 minutes. Other periods of time are contemplated without departing from the scope of the present disclosure. In some embodiments, the particular amount of the glass-based substrate that is removed may be, for example, about 10 μm of material to about 200 μm of material as measured from one of the first major surface and the second major surface, including about 10 μm of material, about 50 μm of material, about 100 μm of material, about 150 μm of material, about 200 μm of material, or any value or range between any two of these values(including endpoints). In particular embodiments, about 42 μm or about 180 μm of material as measured from one of the first major surface and the second major surface may be removed.

The precursor glass substrate may be rinsed of the etchant material. In some embodiments, the precursor glass substrate may be rinsed with a solution containing hydrochloric acid (HCl), such as, for example, a 0.5M HCl solution. In some embodiments, the precursor glass substrate may be rinsed with deionized water. In some embodiments, the precursor glass substrate may be rinsed with a first rinse and subsequently rinsed with a second rinse. For example, the precursor glass substrate may be rinsed with the 0.5M HCl solution and then subsequently rinsed with the deionized water solution. In some embodiments, the precursor glass substrate may be rinsed for a particular period of time to ensure all etchant material has been removed and/or all of the wafer material that was removed from the etchant is separated, such as, for example, about 10 minutes. In a particular embodiment, the precursor glass substrate may be rinsed in the 0.5M HCl solution for 10 minutes and subsequently rinsed with deionized water for 10 minutes.

Ceraming is generally understood to refer to a process of heating a glass precursor. The heating can also be understood to refer to a crystallization process, and nucleation agents can be added to the glass precursor to aide in the crystallization process. Ceraming can generally be understood to occur over two or more steps. A first step can include heating at temperature in a range of from about 500° C. to about 1000° C. or about 700° C. to about 900° C. for a time in a range of from about 1 hour to about 4 hours or about 1 hour to about 3 hours. The first step is followed by heating at a temperature in a range of from about 800° C. to about 1200° C. or about 700° C. to about 900° C. for a time in a range of from about 2 hours to about 6 hours or about 5 hours to about 6 hours.

The first step can be characterized as a nucleation step and the specific temperature at which the first step occurs can be driven by the glass transition temperature (T_{g}) of the precursor glass substrate. For example, the first step can be in a range of from about 75° C. to about 125° C. above a T_{g} of the precursor glass or about 85° C. to about 100° C. above a T_{g} of the precursor glass. Additionally, the second step can be characterized as a crystalline growth step and the specific temperature at which the second step occurs can be driven by the glass transition temperature (T_{g}) of the precursor glass substrate. For example, the first step can be in a range of from about 75° C. to about 225° C. above a T_{g} of the precursor glass or about 85° C. to about 200° C. above a T_{g} of the precursor glass.

The shape of the vias 120 formed is controlled by the order of treating the precursor glass substrate with laser energy, treating the precursor glass substrate with the etchant, and ceraming the etched precursor glass. In addition to selecting the specific order of these steps, the shape of the vias 120 can be controlled by varying the conditions at each step as described herein above. In addition to controlling the shape of the vias 120, the surface characteristics of the vias 120 can also be carefully controlled. For example, an interior surface of each of vias 120 are understood to be substantially smooth. The degree to which the interior surface of each via 120 is smooth can be characterized by the surface roughness of the interior surface. For example, a surface roughness of each of the vias 120 can independently be in a range of from about 1 to about 5 using the scale described herein in the Examples. The degree to which the interior surface of each of vias 120 are smooth can also be visually characterized by observing that the interior surface of the vias 120 are substantially free of a microcrack, a cavitation, a bulge, or a combination thereof.

### EXAMPLES

Various embodiments of the present invention can be better understood by reference to the following Examples which are offered by way of illustration. The present invention is not limited to the Examples given herein.

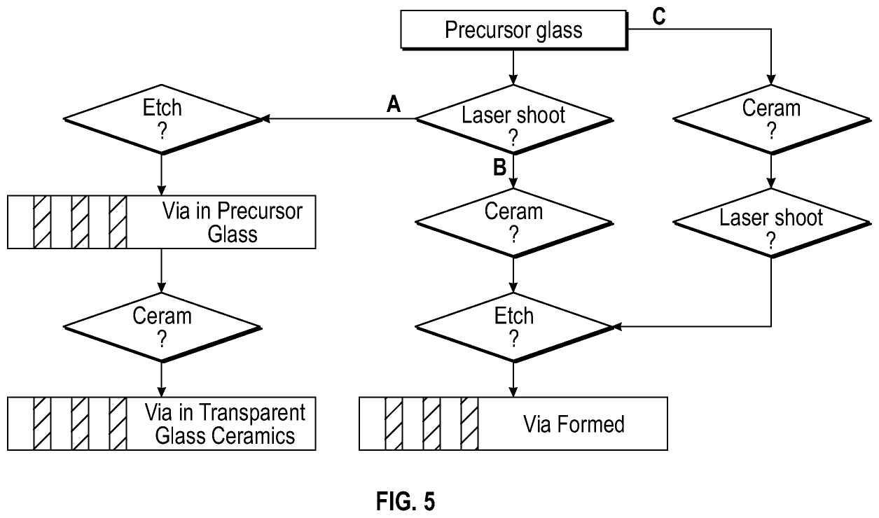

FIG. 5 is a schematic flow diagram showing three possible processes for forming glass ceramic substrates. As shown in FIG. 5, process A proceeds according to the following order: provide precursor glass→laser damage precursor glass→etch precursor glass→form via→ceraming precursor glass. As shown in FIG. 5, process B proceeds according to the following order: provide precursor glass→laser damage precursor glass→ceraming precursor glass→etching ceramed precursor glass→form via-. As shown in FIG. 5, process C proceeds according to the following order: provide precursor glass→ceraming precursor glass→laser damage ceramed precursor glass→etch ceramed precursor glass→form via. It was found that in processes A and B do not require the composition to be transparent glass ceramics while process C requires transparent glass ceramic composition. The combinations of composition of precursor glass, laser damaging, etching and ceraming bring more degrees of process control than using EXG and Lotus glasses as substrates, which could greatly open the composition space and material types and suit then for various requirements in TGV applications. EXG glasses include 67.58 wt % SiO₂. 10.99 wt % Al₂O₃, 9.74 wt % B₂O₃, 2.26 wt % MgO, 8.79 wt % CaO, 0.53 wt % SrO, and 0.08 wt % SnO₂. Lotus glasses include 70.41 wt % SiO₂. 13.31 wt % Al₂O₃, 1.78 wt % B₂O₃, 4.07 wt % MgO, 5.34 wt % CaO, 1.22 wt % SrO, 3.78 wt % BaO, and 0.09 wt % SnO₂

Table 1 provides precursor glass ceramic compositions used to study glass ceramic substrates formed according to the three processing routes in FIG. 5. The results were compared to conventional oxide glass compositions like EXG and Lotus, glass ceramic composition, which contains components that are stoichiometrically close to the composition of interested crystalline phase. Enough nucleus agents (ZrO₂, TiO₂, P₂O₅, etc.) were present in the glass compositions to facilitate crystallization. A nano-size crystalline phase was formed in glass matrix under heat treatment process above T_{g}. The heat treatment process used included two steps, nucleation step of 100° C. above T_{g} and crystalline growth step of 200° C. above T_{g}. The size of crystalline phases was mainly dependent on the crystalline growth time duration, while the amount of crystalline phases was mainly dependent on the nucleation time duration. By keeping the crystalline size under a few μm, the transmittance of glass after ceraming wasn't affected and glass was kept transparent, which allowed the laser beam to go through the sample and make the necessary laser damage for later preferential acid etching.

### Example of Process A

Process A was carried out using Example 1, Example 2 and Example 3, Example 4 and Example 5, Example 7, Example 8 and Example 9, whose compositions are shown in Table 1. The precursor glasses were laser damaged by laser condition of 532 nm wavelength, 15 pulses per burst, 100 kHz repetition rate, and energy range of 70 to 140 μJ and then etched with 5% HF. Vias in precursor glass of Example 1, Example 2 and Example 3, Example 4 and Example 5, Example 7, Example 8 and Example 9 are etched by 5% hydrofluoric acid solution (Table 1, Table 2, Table 3 and Table 4). Components in etchant also have effects on via openings. Table 4 lists the via dimensions for top (um), waist (um) and ratio of D_{w}/D₁ of Example 1, Example 2 and Example 3 etched in 5% HF and (5% HF+10% HNO₃+0.1 Vol % PE), respectively. The poly-electrolyte surfactant Poly(diallyldimethyl) ammonium chloride (PDADMAC) is used as a dynamic masking agent to increase relative diffusion into the vias and will be referred to as PE for simplicity. The effects of etchant are dependent on glass composition.

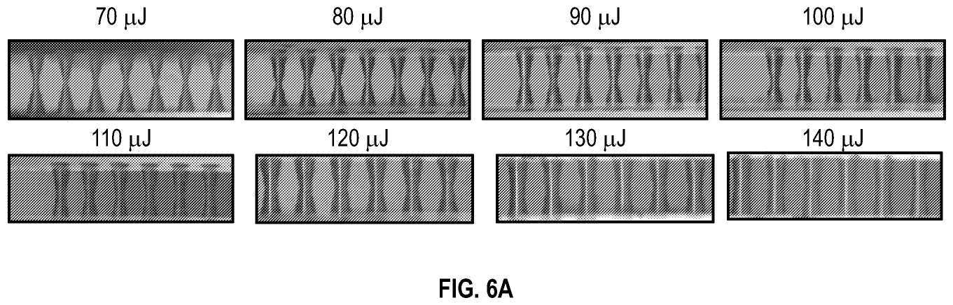

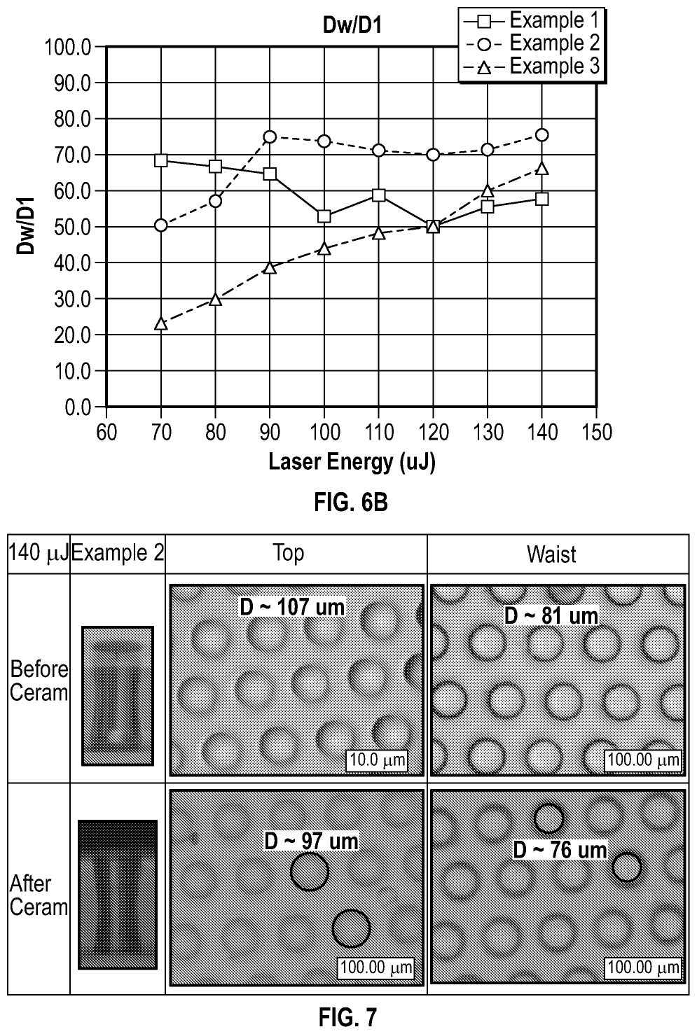

The geometry and aspect ratio of vias of some precursor glasses can be tuned by laser power, which has significant effect on the via shape and top diameter. As shown in FIGS. 6A and 6B, Example 3 can have its aspect ratio of D_{w}/D₁ (waist diameter/top diameter) tuned in the range of 20%-70%. With an increasing in laser power, the via shape is changed from more taper shape to more cylindrical shape. This indicated that the glass ceramics compositions were sensitive to laser damage. After ceraming at 800° C. for 2 hours and then 1000° C. for 4 hours, ceramed Example 1, Example 2 and Example 3 are still transparent with an increase in CTE (ppm/° C.) of 20-35% and an increase in density (g/cm³) of 2-3% (Table 3). XRD showed that a gahnite (ZnAlO₄) phase formed for Example 1, Example 2 and Example 3 glass composition after ceraming. FIG. 7 shows that the existing vias in glass precursor Example 2 shrink 5-10 μm in diameter in process A, no cracking, warping or negative deformation of the via was observed.

Glass Ceramic Example 1 was measured under the VIEW Summit 650Q metrology tool before and after heat treatment for positional accuracy and hole morphology. A rectangular grid 42×21 of vias at 150 um pitch was measured.

### Hole Morphology

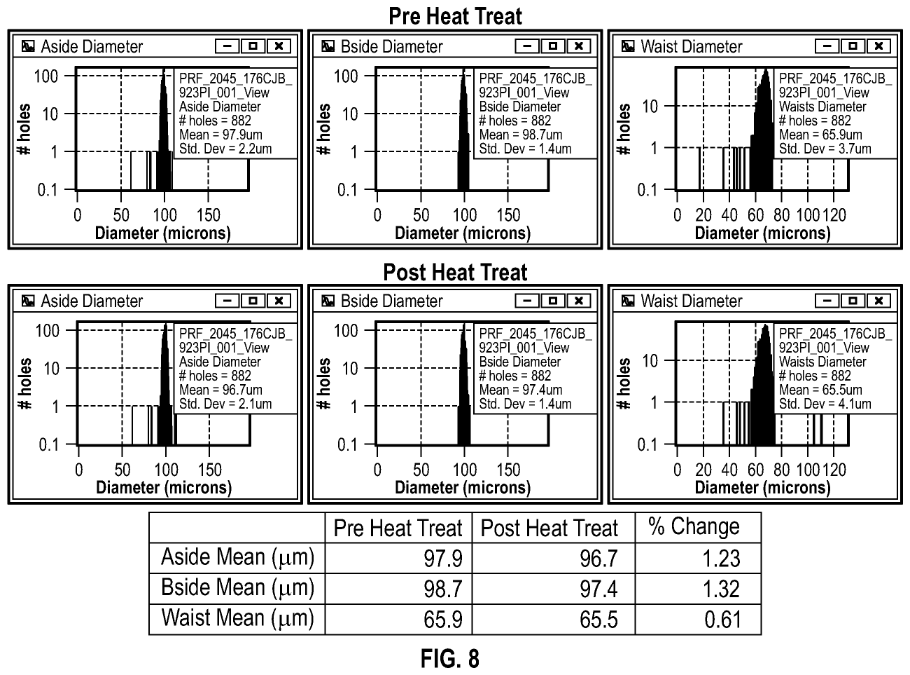

A side, B side, and waist diameters were measured for all of the 882 vias on a sample. The histograms shown in FIG. 8 show the statistics of the via morphologies before and after heat treatment. The distributions and deviations of the plots stay relatively the same, however there is roughly a 1% decrease in diameters/shrinking of the vias. This was noted in profile view images of the vias before and after heat treatment. The shrinkage was expected and predictable, based on the heat treatment process conditions. Thus, the via diameters were initially made larger, so they shrink to the targeted diameter. The heat treatment process was accomplished prior to any downstream processes such as metallization to account for this shrinkage.

### Positional Accuracy

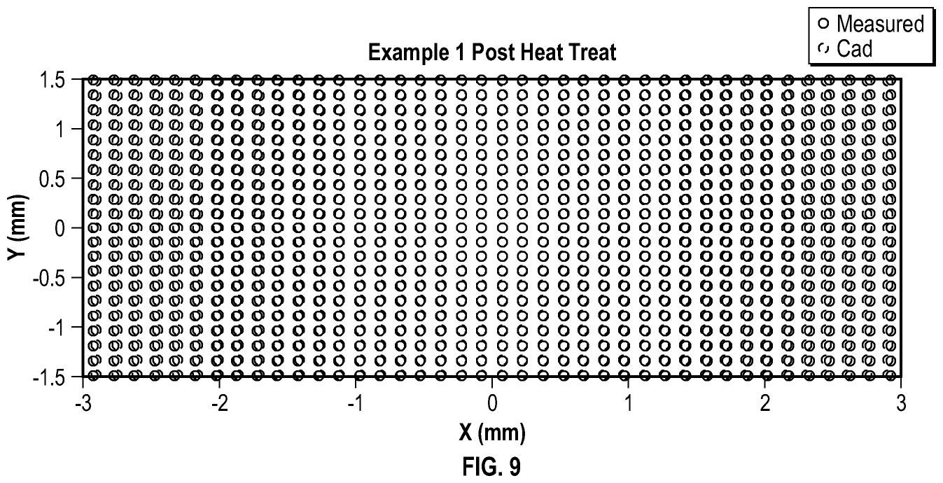

The heat treatment process isotropically compressed the sample by ˜1% (See FIG. 9), which shows the location of the vias post heat treatment (solid line) have shifted towards the center of the array compared with the nominal CAD(pattern)locations of the vias (dashed line). This 1% compression agreed with the shrinkage seen in morphology. This degree of compaction is typical and can be modelled. If the heat treatment process is fixed, the displacement of the vias can be modeled and vias can be originally placed in locations to account for this.

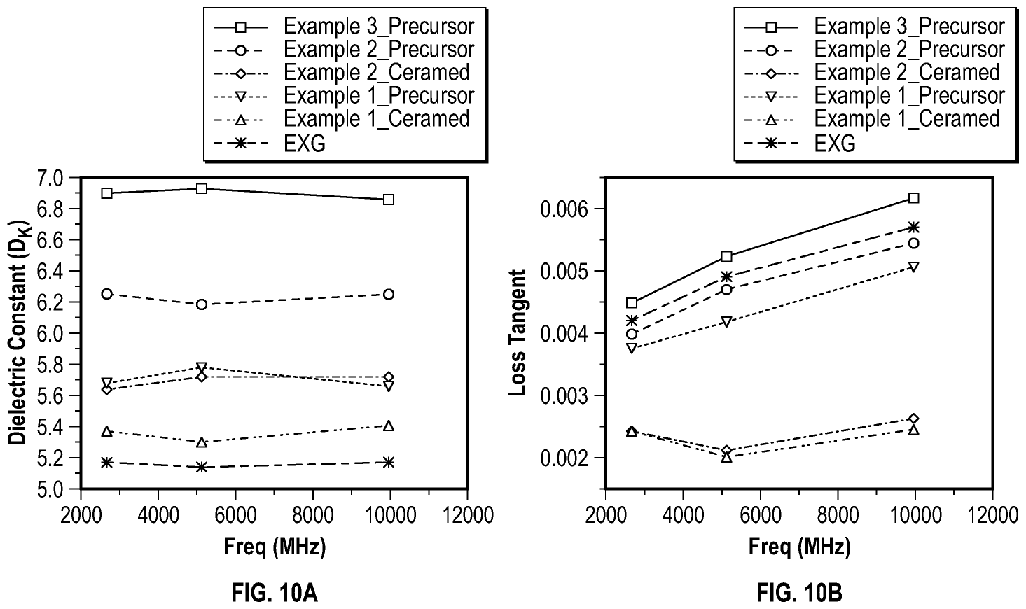

Glass ceramics formed according the Examples herein showed advantages over precursor glasses and EXG in terms of dielectric properties for TGV applications. Glass ceramics have lower dielectric constant (D_{K}) than precursor glasses (FIG. 10A) and lower loss tangent (lower energy loss) than precursor glasses and EXG (FIG. 10B). Low dielectric constant values are preferred for high frequency or power applications to minimize electric power loss. High values of dielectric constant are recommended for capacitance applications of small sizes. Dielectric properties are measured based on ASTM D-150 “A-C Loss Characteristics and Permittivity (Dielectric Constant) of Solid Electrical Insulating Materials” in the range of microwave (2 GHz-10 GHz), using thin sheet sample of 3″×3″ and thickness less than 0.9 mm. FIG. 10B shows that after ceraming, loss tangent decreased 35-55% comparing to precursor glasses and EXG, and dielectric properties of precursor glasses were significantly improved after ceraming.

### Example of Process B

Process B was studied to examine whether the ceraming step could amplify the differential etching rate in damaged area and result in a much quicker via forming rate. The compositions of Example 4 and Example 5, which went through laser damaging then ceraming process, showed that no holes or trace of laser damage were observed before or after etching in any of the samples for over 9 hours etching. This indicated that the ceraming process erased the laser damage history for some of the glass ceramic compositions.

### Example of Process C

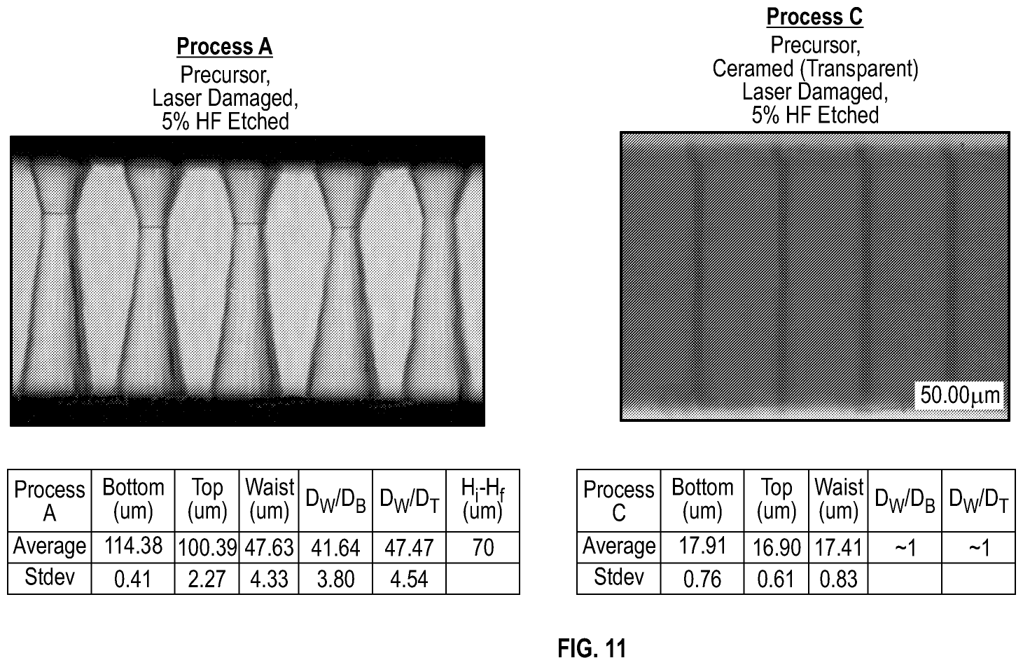

Process C was studied to see if the chemistry and/or structure after laser damage could cause a differential etching rate for transparent glass ceramics comparing to that for precursor glass in Process A. Glass ceramics showed much slower etching rates than precursor glass. In FIG. 11, comparing to Process A for Example 9, Process C resulted in very narrow and cylindrical shape via without measurable thickness change in 2 um. This indicated that the proper ceraming process could result in different dimensions of final via for different through-glass via applications.

TABLE 1

| Material | | | | | | | | | | |
|---|---|---|---|---|---|---|---|---|---|---|
| (mol %) | EXG | Example 1 | Example 2 | Example 3 | Example 4 | Example 5 | Example 6 | Example 7 | Example 8 | Example 9 |
| SiO₂ | 67.5 | 68.2 | 62.3 | 54.2 | 55.91 | 55.91 | 50.91 | 65 | 65 | 65 |
| Al₂O₃ | 11.1 | 12.9 | 15.3 | 18.6 | 18.65 | 18.65 | 21.15 | 14 | 14 | 14 |
| B₂O₃ | 9.8 | 0 | 0 | 0 | 0 | 0 | 0 | 0 | 0 | 0 |
| MgO | 2.3 | 4.3 | 5.1 | 6.2 | 1.79 | 0 | 0 | 5 | 5 | 14 |
| CaO | 8.8 | 0 | 0 | 0 | 0 | 0 | 0 | 0 | 0 | 0 |
| SrO | 0.5 | 0 | 0 | 0 | 0 | 0 | 0 | 0 | 0 | 0 |
| BaO | | 1 | 1.1 | 1.4 | 0 | 1.79 | 1.79 | 0 | 0 | 0 |
| ZnO | 0 | 7.6 | 9 | 11 | 18.65 | 18.65 | 21.15 | 9 | 9 | 0 |
| ZrO₂ | 0 | 1.7 | 2 | 2.4 | 5 | 5 | 5 | 0 | 2 | 2 |
| TiO₂ | 0 | 4.3 | 5.1 | 6.2 | 0 | 0 | 0 | 7 | 5 | 5 |
| SnO₂ | 0.1 | 0 | 0 | 0 | 0 | 0 | 0 | 0 | 0 | 0 |
| Total | 100 | 100 | 100 | 100 | 100 | 100 | 100 | 100 | 100 | 100 |
| Etchant | 5% HF¹ | 5% HF | 5% HF | 5% HF | 5% HF | 5% HF | 5% HF | 5% HF | 5% HF | 5% HF |
| Actual | 108.05 | 106.2 | 108.5 | 108.35 | 126.5 | 134.2 | 174.65 | 14.8 | 133.95 | 2 |
| removal | | | | | | | | | | |
| (um) | | | | | | | | | | |
| Time | 407 | 337 | 407 | 322 | 362.5 | 377.5 | 277 | 1244 | 423 | 1244 |
| (min) | | | | | | | | | | |
| Etch Rate | 0.265 | 0.315 | 0.267 | 0.336 | 0.349 | 0.355 | 0.631 | 0.012 | 0.317 | 0.002 |
| (um/min) | | | | | | | | | | |

¹5 volume % of a 50 wt % stock solution of hydrofluoric acid (applies to HF as used in Table 1)

TABLE 2

| Laser | Example 4 | | | Example 5 | | | Example 6 | | |
|---|---|---|---|---|---|---|---|---|---|
| energy | Top | Waist | | Top | Waist | | Top | Waist | |
| (μJ) | (μm) | (μm) | D_{w}/Dₗ | (μm) | (μm) | D_{w}/Dₗ | (μm) | (μm) | D_{w}/Dₗ |
| 70 | 90.5 ± 2.8 | 33.6 ± 4.3 | 38.1% | 104.1 ± 3.8 | 59.8 ± 6.1 | 57.5% | 139.2 ± 3.8 | 78.9 ± 4.1 | 56.7% |
| 100 | 96.2 ± 4.1 | 36.4 ± 3.9 | 38.4% | 107.6 ± 5.7 | 60 ± 9.8 | 55.6% | | | |

TABLE 3

| | Top (μm) | Waist (μm) | D_{w}/D₁ | Hᵢ − H_{f} (μm) |
|---|---|---|---|---|
| Example 7 | 93.0 ± 0.3 | 22.2 ± 6.6 | 23.9% | 70 |
| Example 8 | 94.4 ± 0.8 | 46.9 ± 7.5 | 49.7% | 60 |
| Example 9 | 100.4 ± 2.3 | 47.6 ± 4.3 | 47.5% | 70 |

TABLE 4

| Laser burst 20, | Etchant of 5% HF² | | | Etchant of 5% HF³ + 1% HNO₃⁴ + 0.1% PE⁵ | | |
|---|---|---|---|---|---|---|
| 532 nm, 100 kHz | Top (μm) | Waist (μm) | D_{w}/Dₗ | Top (μm) | Waist (μm) | D_{w}/Dₗ |
| Example 1 precursor glass | | | | | | |
| 70 μJ | 107.8 ± 1.5 | 73.8 ± 1.6 | 68.4% | 96.5 ± 2.3 | 35.3 ± 7.7 | 35.5% |
| 140 μJ | 98.6 ± 1.5 | 57.0 ± 2.0 | 57.8% | 101.9 ± 0.9 | 88.2 ± 2.9 | 81.9% |
| Example 2 precursor glass | | | | | | |
| 70 μJ | 119.2 ± 2.6 | 60.0 ± 9.3 | 50.3% | 87.7 ± 1.8 | 17.3 ± 3.9 | 21.5% |
| 140 μJ | 107.4 ± 1.0 | 81.1 ± 1.7 | 75.5% | 100.4 ± 1.2 | 53.5 ± 1.8 | 59.6% |
| Example 3 precursor glass | | | | | | |
| 70 μJ | 100.7 ± 0.5 | 23.5 ± 0.1 | 23.3% | 91.6 ± 1.2 | 45.4 ± 3.9 | 49.3% |
| 140 μJ | 105.8 ± 0.8 | 70.4 ± 3.4 | 66.6% | 101.4 ± 1.3 | 84.5 ± 2.5 | 82.7% |

TABLE 5

| | precursor glass | | glass ceramics | |
|---|---|---|---|---|
| | Density | CTE | after 800 C./2 hr, then 1000 C./4 hr | |
| Glass code | (g/cm³) | (ppm/° C.) | Density (g/cm³) | CTE (ppm/° C.) |
| Example 1 | 2.686 | 2.85 | 2.754 | 3.59 |
| Example 2 | 2.800 | 3.28 | 2.861 | 4.08 |
| Example 3 | 2.955 | 3.49 | 3.038 | 4.61 |

² 5 volume % of a 50 wt % stock solution of hydrofluoric acid
³5 volume % of a 50 wt % stock solution of hydrofluoric acid
⁴ 10 volume % of a HNO₃ stock solution of 70% HNO₃.
⁵ 0.1 volume % of a stock solution of PDAMAC (Poly(diallyldimethyhylammonium chloride) solution that is 35 wt % PDAMAC in H₂O.

### Surface Roughness

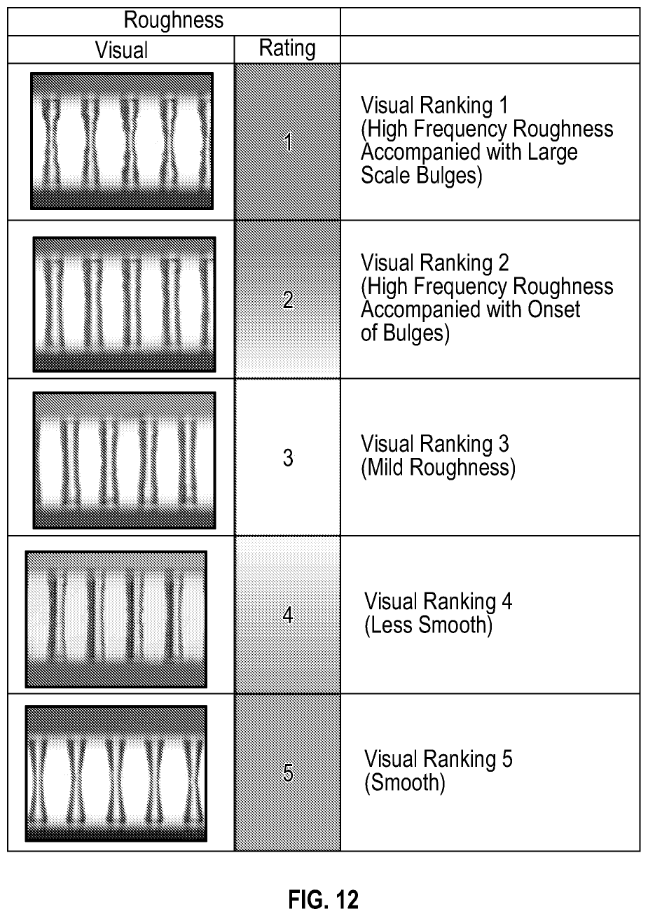

Surface roughness was evaluated by visually ranking the interior wall roughness of 1-5. A ranking of 1 correlated to a high frequency roughness accompanied with large scale bulges. A ranking of 2 correlated to a high frequency roughness accompanied with onset of bulges. A ranking of 3 correlated to mild roughness. A ranking of 4 correlated to a less than smooth surface. A ranking of 5 correlated to a smooth surface. FIG. 12 shows an example of a visual ranking of a variety of vias.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Exemplary Embodiments

The following exemplary embodiments are provided, the numbering of which is not to be construed as designating levels of importance:

Embodiment 1 provides a method of forming a glass ceramic substrate having a through-glass via, the method comprising:
at least one of:
   treating at least a portion of a first major surface of a precursor glass substrate along a laser scan path with a source of laser energy to form a treated precursor glass substrate, treating the treated precursor glass substrate with an etchant to form an etched precursor glass substrate, and ceraming the etched treated precursor glass to form substrate comprising the through-glass via;
   treating at least a portion of a first major surface of a precursor glass substrate along a laser scan path with a source of laser energy to form a treated precursor glass substrate, ceraming the treated precursor glass substrate to form a treated ceramed precursor glass substrate, and treating the treated ceramed precursor glass substrate with an etchant to form a glass ceramic substrate comprising the through-glass via; and
   ceraming a precursor glass substrate to form a ceramed precursor glass substrate, treating at least a portion of a first major surface of the ceramed precursor glass substrate along a laser scan path with a source of laser energy to form a treated ceramed precursor glass substrate, treating the treated ceramed precursor glass substrate with an etchant to form an etched ceramed precursor glass substrate to form a glass ceramic substrate comprising the through-glass via in the glass ceramic substrate, wherein
the through-glass via has a predetermined shape and extends through the first major surface of the glass ceramic substrate and a second major surface of the glass ceramic substrate, the first major surface defining a first opening and the second major surface defining a second opening and a ratio of a waist diameter of the through-glass via, measured at a location between the first opening and the second opening, to a surface diameter of the through-glass via, measured at either the first opening of the second opening of the through-glass via is in a range of from about 30% to about 100%.

Embodiment 2 provides the method of Embodiment 1, wherein the glass ceramic substrate comprising the through-glass via that is substantially free of an alkali metal ion.

Embodiment 3 provides the method of any one of Embodiments 1 or 2, wherein the glass ceramic substrate is substantially transparent.

Embodiment 4 provides the method of Embodiment 3, wherein the glass ceramic substrate is transparent over a thickness of about 0.3 mm to about 1.5 mm.

Embodiment 5 provides the method of any one of Embodiments 1-4, wherein the glass ceramic substrate comprises SiO₂(50 to 70 mol %), Al₂O₃(12 to 22 mol %), B₂O₃(0 mol %), a mixture of: MgO, CaO, SrO, and BaO (0 to 15 mol %), MgO (0 to 15 mol %), BaO (0 to 2 mol %), ZnO (0 to 22 mol %), ZrO₂(0 to 6 mol %), TiO₂(0-8 mol %), SnO₂(0.01-0.1 mol %), or a mixture thereof.

Embodiment 6 provides the method of any one of Embodiments 1-5, wherein the laser energy has a strength in a range of from about 50 μJ to about 170 μJ.

Embodiment 7 provides the method of any one of Embodiments 1-6, wherein the laser energy has a strength in a range of from about 70 μJ to about 140 μJ.

Embodiment 8 provides the method of any one of Embodiments 1-7, wherein the etchant comprises an acid.

Embodiment 9 provides the method of Embodiment 8, wherein the acid comprises hydrofluoric acid, nitric acid, hydrochloric acid, sulfuric acid, or a mixture thereof and a concentration of the acid in the etchant is in a range of from about 2 vol % to about 15 vol %.

Embodiment 10 provides the method of Embodiment 9, wherein the etchant comprises a mixture of hydrofluoric acid and nitric acid.

Embodiment 11 provides the method of any one of Embodiments 1-10, wherein etching further comprises applying a masking agent to at least a portion of the precursor glass.

Embodiment 12 provides the method of Embodiment 11, wherein the masking agent comprises poly(diallyldimethyl) ammonium chloride.

Embodiment 13 provides the method of any one of Embodiments 1-12, wherein the through-glass via has a substantially hour-glass shape and the ratio of a waist diameter to a surface diameter of the through-glass via is in a range of from about 10% to about 75%.

Embodiment 14 provides the method of any one of Embodiments 1-13, wherein the through-glass via has a substantially hour-glass shape and the ratio of a waist diameter to a surface diameter of the through-glass via is in a range of from about 10% to about 50%.

Embodiment 15 provides the method of any one of Embodiments 1-14, wherein the through-glass via has a substantially cylindrical shape and the ratio of a waist diameter to a surface diameter of the through-glass via is in a range of from about 76% to about 100%.

Embodiment 16 provides the method of any one of Embodiments 1-15, wherein the through-glass via has a substantially cylindrical shape and the ratio of a waist diameter to a surface diameter of the through-glass via is in a range of from about 90% to about 100%.

Embodiment 17 provides the method of any one of Embodiments 1-16, wherein the ceraming is performed by heating at temperature in a range of from about 500° C. to about 1000° C. for a time in a range of from about 1 hour to about 4 hours followed by heating at a temperature in a range of from about 800° C. to about 1200° C. for a time in a range of from about 2 hours to about 6 hours.

Embodiment 18 provides the method of any one of Embodiments 1-17, wherein the ceraming is performed by heating at temperature in a range of from about 700° C. to about 900° C. for a time in a range of from about 1 hour to about 3 hours followed by heating at a temperature in a range of from about 900° C. to about 1100° C. for a time in a range of from about 3 hours to about 5 hours.

Embodiment 19 provides the method of any one of Embodiments 1-18, wherein ceraming comprises:
a first nucleation step that is in a range of from about 50° C. to about 150° C. above a T_{g} of the precursor glass; and
a crystalline growth step that in a range of from about 150° C. to about 250° C. above a T_{g} of the precursor glass.

Embodiment 20 provides the method of any one of Embodiments 1-19, wherein ceraming comprises:
a first nucleation step that is in a range of from about 75° C. to about 125° C. above a T_{g} of the precursor glass; and
a crystalline growth step that in a range of from about 175° C. to about 225° C. above a T_{g} of the precursor glass.

Embodiment 21 provides the method of any one of Embodiments 1-20, wherein a dielectric constant of the glass ceramic substrate is lower than a dielectric constant of the precursor glass.

Embodiment 22 provides the method of any one of Embodiments 1-21, wherein a coefficient of thermal expansion of the glass substrate is increased by about 15% to about 40% relative to the glass precursor.

Embodiment 23 provides the method of any one of Embodiments 1-22, wherein a coefficient of thermal expansion of the glass substrate is increased by about 20% to about 35% relative to the glass precursor.

Embodiment 24 provides the method of any one of Embodiments 1-23, wherein a density of the glass substrate is increased by about 1% to about 4% relative to the glass precursor.

Embodiment 25 provides the method of any one of Embodiments 1-24, wherein a density of the glass substrate is increased by about 2% to about 3% relative to the glass precursor.

Embodiment 26 provides the method of any one of Embodiments 1-25, wherein etching occurs for a time in a range of from about 250 minutes to about 1500 minutes.

Embodiment 27 provides the method of any one of Embodiments 1-26, wherein etching occurs for a time in a range of from about 270 minutes to about 1250 minutes.

Embodiment 28 provides the method of any one of Embodiments 1-27, wherein a etch rate of the precursor glass is in a range of from about 0.001 μm (of precursor glass material)/min to about 0.700 μm/min.

Embodiment 29 provides the method of any one of Embodiments 1-28, wherein a etch rate of the precursor glass is in a range of from about 0.002 μm/min to about 0.640 μm/min.

Embodiment 30 provides the method of any one of Embodiments 1-29, wherein a major diameter of the through-glass via is in a range of from about 10 μm to about 150 μm.

Embodiment 31 provides the method of any one of Embodiments 1-30, wherein a major diameter of the through-glass via is in a range of from about 15 μm to about 20 μm.

Embodiment 32 provides the method of any one of Embodiments 1-31, wherein an internal surface of the glass-through via is substantially smooth.

Embodiment 33 provides the method of any one of Embodiments 1-32, wherein a surface roughness of an internal surface of the glass-through via is in a range of from about 4 to about 5.

Embodiment 34 provides the method of any one of Embodiments 1-33, wherein a surface roughness of an internal surface of the glass-through via is in a range of from about 4 to about 5.

Embodiment 35 provides the method of any one of Embodiments 1-34, wherein an internal surface of the through-glass via is substantially free of a microcrack, a cavitation, a bulge, or a combination thereof.

Embodiment 36 provides the method of any one of Embodiments 1-35, further comprising filling the through-glass via with an electronically conductive metal.

Embodiment 37 provides the method of Embodiment 36, wherein the electronically conductive metal comprises copper.

Embodiment 38 provides the method of anyone of Embodiments 36 or 37, wherein filling the through-glass via with the electronically conductive metal comprises electroplating.

Embodiment 39 provides a glass ceramic substrate formed according to the method of any one of Embodiments 1-38.

Embodiment 40 provides a glass ceramic substrate comprising:
a plurality of through-glass vias independently having a major diameter in a range of from about 10 μm to about 150 μm, wherein
   the through-glass via extends through a first major surface of the glass ceramic substrate and a second major surface of the glass ceramic substrate, the first major surface defining a first opening and the second major surface defining a second opening and a ratio of a waist diameter of the through-glass via, measured at a location between the first opening and the second opening, to a surface diameter of the through-glass via, measured at either the first opening of the second opening of the through-glass via is in a range of from about 30 to about 100; and
   the glass ceramic substrate is substantially free of an alkali earth metal.

Embodiment 41 provides the glass ceramic substrate of Embodiment 40, wherein the through-glass via has a substantially hour-glass shape and the ratio of a waist diameter to a surface diameter of the through-glass via is in a range of from about 10% to about 75%.

Embodiment 42 provides the glass ceramic substrate of any one of Embodiments 40 or 41, wherein the through-glass via has a substantially hour-glass shape and the ratio of a waist diameter to a surface diameter of the through-glass via is in a range of from about 10% to about 50%.

Embodiment 43 provides the glass ceramic substrate of any one of Embodiments 40-42, wherein the through-glass via has a substantially cylindrical shape and the ratio of a waist diameter to a surface diameter of the through-glass via is in a range of from about 76% to about 100%.

Embodiment 44 provides the glass ceramic substrate of any one of Embodiments 40-43, wherein the through-glass via has a substantially cylindrical shape and the ratio of a waist diameter to a surface diameter of the through-glass via is in a range of from about 90% to about 100%.

Embodiment 45 provides the glass ceramic substrate of any one of Embodiments 40-44, wherein a dielectric constant of the glass ceramic substrate is lower than a dielectric constant of a precursor glass from which the glass ceramic substrate is formed.

Embodiment 46 provides the glass ceramic substrate of any one of Embodiments 40-45, wherein a coefficient of thermal expansion of the glass substrate is increased by about 15% to about 40% relative to the precursor glass from which the glass ceramic substrate is formed.

Embodiment 47 provides the glass ceramic substrate of any one of Embodiments 40-46, wherein a coefficient of thermal expansion of the glass substrate is increased by about 20% to about 35% relative to the precursor glass from which the glass ceramic substrate is formed.

Embodiment 48 provides the glass ceramic substrate of any one of Embodiments 40-47, wherein a major diameter of the through-glass via is in a range of from about 10 μm to about 150 μm.

Embodiment 49 provides the glass ceramic substrate of any one of Embodiments 40-48, wherein a major diameter of the through-glass via is in a range of from about 15 μm to about 20 μm.

Embodiment 50 provides the glass ceramic substrate of any one of Embodiments 40-49, wherein an internal surface of the glass-through via is substantially smooth.

Embodiment 51 provides the glass ceramic substrate of any one of Embodiments 40-50, wherein a surface roughness of an internal surface of the glass-through via is in a range of from about 4 to about 5.

Embodiment 52 provides the glass ceramic substrate of any one of Embodiments 40-51, wherein a surface roughness of an internal surface of the glass-through via is in a range of from about 4 to about 5.

Embodiment 53 provides the glass ceramic substrate of any one of Embodiments 40-52, wherein an internal surface of the through-glass via is substantially free of a microcrack, a cavitation, a bulge, or a combination thereof.

Embodiment 54 provides the glass ceramic substrate of any one of Embodiments 40-53, wherein the plurality of through-glass vias are distributed according to a predetermined pattern.

Embodiment 55 provides the glass ceramic substrate of any one of Embodiments 40-54, wherein the glass ceramic substrate is substantially transparent.

Embodiment 56 provides the glass ceramic substrate of Embodiment 55, wherein the glass ceramic substrate has a transparency of about 75% to 100% over a thickness of about 0.3 mm to about 1.5 mm.

Embodiment 57 provides the glass ceramic substrate of any one of Embodiments 40-56, wherein the glass ceramic substrate comprises a redistribution layer, an interposer, or a micro-LED.

Embodiment 58 provides the glass ceramic substrate of any one of Embodiments 40-57, wherein at least a portion of the through-glass vias are filled with an electronically conductive metal.

Embodiment 59 provides the glass ceramic substrate of Embodiment 58, wherein the electronically conductive metal comprises copper.

1. A method of forming a glass ceramic substrate having a through-glass via, the method comprising:
at least one of:
treating at least a portion of a first major surface of a precursor glass substrate along a laser scan path with a source of laser energy to form a treated precursor glass substrate, treating the treated precursor glass substrate with an etchant to form an etched precursor glass substrate, and ceraming the etched treated precursor glass to form substrate comprising the through-glass via;
treating at least a portion of a first major surface of a precursor glass substrate along a laser scan path with a source of laser energy to form a treated precursor glass substrate, ceraming the treated precursor glass substrate to form a treated ceramed precursor glass substrate, and treating the treated ceramed precursor glass substrate with an etchant to form a glass ceramic substrate comprising the through-glass via; and
ceraming a precursor glass substrate to form a ceramed precursor glass substrate, treating at least a portion of a first major surface of the ceramed precursor glass substrate along a laser scan path with a source of laser energy to form a treated ceramed precursor glass substrate, treating the treated ceramed precursor glass substrate with an etchant to form an etched ceramed precursor glass substrate to form a glass ceramic substrate comprising the through-glass via in the glass ceramic substrate, wherein
the through-glass via has a predetermined shape and extends through the first major surface of the glass ceramic substrate and a second major surface of the glass ceramic substrate, the first major surface defining a first opening and the second major surface defining a second opening and a ratio of a waist diameter of the through-glass via, measured at a location between the first opening and the second opening, to a surface diameter of the through-glass via, measured at either the first opening or the second opening of the through-glass via is in a range of from about 30% to about 100%.

2. The method of claim 1, wherein the glass ceramic substrate comprising the through-glass via that is substantially free of an alkali metal.

3. The method of claim 1, wherein the glass ceramic substrate comprises SiO₂ (50 to 70 mol %), Al₂O₃(12 to 22 mol %), B₂O₃(0 mol %), a mixture of: MgO, CaO, SrO, and BaO (0 to 15 mol %), MgO (0 to 15 mol %), BaO (0 to 2 mol %), ZnO (0 to 22 mol %), ZrO₂(0 to 6 mol %), TiO₂(0-8 mol %), SnO₂ (0.01-0.1 mol %), or a mixture thereof.

4. The method of claim 1, wherein the laser energy has a strength in a range of from about 50 μJ to about 170 μJ.

5. The method of claim 1, wherein the etchant comprises an acid.

6. The method of claim 5, wherein the acid comprises hydrofluoric acid, nitric acid, hydrochloric acid, sulfuric acid, or a mixture thereof and a concentration of the acid in the etchant is in a range of from about 2 vol % to about 15 vol %.

7. The method of claim 1, wherein the through-glass via has a substantially hour-glass shape and the ratio of a waist diameter to a surface diameter of the through-glass via is in a range of from about 10% to about 75%.

8. The method of claim 1, wherein the through-glass via has a substantially cylindrical shape and the ratio of a waist diameter to a surface diameter of the through-glass via is in a range of from about 76% to about 100%.

9. The method of claim 1, wherein the ceraming is performed by heating at temperature in a range of from about 500° C. to about 1000° C. for a time in a range of from about 1 hour to about 4 hours followed by heating at a temperature in a range of from about 800° C. to about 1200° C. for a time in a range of from about 2 hours to about 6 hours.

10. The method of claim 1, wherein ceraming comprises:
a first nucleation step that is in a range of from about 50° C. to about 150° C. above a T_{g} of the precursor glass; and
a crystalline growth step that in a range of from about 150° C. to about 250° C. above a T_{g} of the precursor glass.

11. The method of claim 1, wherein a dielectric constant of the glass ceramic substrate is lower than a dielectric constant of the precursor glass.

12. The method of claim 1, wherein a coefficient of thermal expansion of the glass substrate is increased by about 15% to about 40% relative to the glass precursor.

13. The method of claim 1, wherein a density of the glass substrate is increased by about 1% to about 4% relative to the glass precursor.

14. The method of claim 1, wherein a etch rate of the precursor glass is in a range of from about 0.001 μm (of precursor glass material)/min to about 0.700 μm/min.

15. The method of claim 1, wherein a major diameter of the through-glass via is in a range of from about 10 μm to about 150 μm.

16. The method of claim 1, wherein an internal surface of the glass-through via is substantially smooth.

17. A glass ceramic substrate comprising:
a plurality of through-glass vias independently having a major diameter in a range of from about 10 μm to about 150 μm, wherein
the through-glass via extends through a first major surface of the glass ceramic substrate and a second major surface of the glass ceramic substrate, the first major surface defining a first opening and the second major surface defining a second opening and a ratio of a waist diameter of the through-glass via, measured at a location between the first opening and the second opening, to a surface diameter of the through-glass via, measured at either the first opening or the second opening of the through-glass via is in a range of from about 30% to about 100%; and
the glass ceramic substrate is substantially free of an alkali earth metal.

18. The glass ceramic substrate of claim 17, wherein the through-glass via has a substantially hour-glass shape and the ratio of a waist diameter to a surface diameter of the through-glass via is in a range of from about 10% to about 75%.

19. The glass ceramic substrate of claim 17, wherein the through-glass via has a substantially cylindrical shape and the ratio of a waist diameter to a surface diameter of the through-glass via is in a range of from about 76% to about 100%.

20. The glass ceramic substrate of claim 17, wherein an internal surface of the glass-through via is substantially smooth.
